(19) United States
(12) Patent Application Publication
(10) Pub. No.: US 2012/0201150 A1
(43) Pub. Date: Aug. 9, 2012

(54) EFFECTIVE METHOD OF MEASURING WIRELESS CONSUMER EXPERIENCE INSIGHTS

(75) Inventors: Sayaji Hande, Ghaziabad (IN); Amit Verma, Flowermound, TX (US)

(73) Assignee: NextGen Innovation Labs LLC, Addison, TX (US)

(21) Appl. No.: 13/022,907

(22) Filed: Feb. 8, 2011

(51) Int. Cl. H04W 24/00

(52) U.S. Cl. 370/252

(57) ABSTRACT

Apparatus and methods for measuring consumer experience through an optimal user panel within predetermined error rate, or any other categorization for wireless domain. The data is collected at the panel member's wireless device. Categorization of data is based on but not limited to, product groupings and market segments. To minimize the cost of the method while having the estimate of consumer experience within aforesaid error rates, the panel members are chosen such that they can provide the most informative data of usage for the parameters that effect consumer experience, such as wireless network usage, usage of applications, sequence thereof among others. The focal point of data collection will be to trace the failure rate in the wireless network, devices, application among others. Thus we can apply suitable statistical models of prediction, such as but not limited to Poisson distribution and Empirical Bayes technique. Thus an optimal and more accurate quantitative measure of the estimate is made. By providing for performance statistics of consumer experience, it can readily be determined if a performance problem is related to the device, to the network and can also compare various factors such as but not limited to service providers, software platforms on wireless devices, different market segments using the wireless devices.

### TECHNICAL FIELD

The present disclosure relates to methods and systems for determining the performance of a wireless network, more particularly by collection of the most informative data.

### BACKGROUND

The methodology commonly used to assess the status of wireless network of various operators includes various devices in conjunction with service providers and is driven by the pattern of calls exchanged. This system has been designed to address ‘coverage’ based on different parameters including but not limited to geographical regions. The methodology involves expensive ‘drive tests’—across the country and regions. The regions are called ‘markets’, primarily segments that are basically clusters where network issues, optimization, infrastructure can be addressed.

It is clear from above ‘drive test’ methodology that it was appropriate and feasible in an early stage of wireless networks. Clearly, the usage of wireless has been growing exponentially and usage patterns are changing substantially.

In recent times, device-built monitors, probes, agents etc. have been created to collate the relevant data. A careful planning of this could lead to appropriate assessment. In the current literature, there is no clear methodology which would address the issues of accuracy and data precision for the estimates provided.

In US Patent Application US 2005/0010472, entitled “High-Precision Customer-Based Targeting by Individual Usage Statistics”, which is incorporated herein by reference, a system to find out the best option for a customer has been disclosed. The said system is based on past purchase data, normalization information and other factors a set of offers are presented to each individual user with their associated probabilities. From the set of offers, the choice of which offers to be given to which user is driven by business plans and past usage behavior and a normalization rate. Few offers which the user is most likely to accept are to be presented to him, not based only on offers he has used earlier but also the other aspects of his usage and the category which the user belongs to.

In another U.S. Pat. No. 7,751,385, entitled “Systems and Methods for Collecting and Disbursing Participant Identifying Data”, also incorporated herein by reference, a system is to predict wireless network resource usage by analyzing and monitoring events on wireless devices is disclosed. A metering component resides on the wireless device of a user and then based on the analysis of data from a large number of such users, the network performance is predicted. Data from device is collected because it gives more information than from the network but since the process involves collection of a huge amount of data, processing takes more time and resources.

### SUMMARY

Disclosed below is a system for determining performance of a wireless network. The wireless network includes a plurality of members having wireless communication devices in communication with the wireless network. The system comprises of a mobile network interface that is configured to obtain usage data of the wireless communication devices. The usage data includes any wireless network events. The system further comprises of a database for storing the usage data of the plurality of members and an analytics processor for sorting the plurality of members in order of maximum number of past network events in a predetermined time period and further sorting the network events in to different categories by applying at least one desired parameter. The analytics processor is further configured to choose a predetermined number of panel members with preference to those members having a higher number of network events in a higher number of categories for the desired parameter. The analytics processor is further configured to give preference to those members that reduce the variation in the total number of network events in the different categories for the selected panel members, wherein the performance of the wireless network is determined by analysis of usage patterns of the panel formed from the selected panel members.

Also disclosed herein is a method for determining performance of a wireless network. The method comprises of selecting a set of panel members from a list of members of the wireless network that comprises of sorting the list of members in order of maximum number of past events in a predetermined time period and further sorting the events in to different categories by applying at least one desired parameter. The method further comprises of choosing a predetermined number of panel members with preference to those members having a higher number of events in a higher number of categories for the desired parameter and additionally giving preference to those members that reduce the variation in the total number of events in the different categories for the selected panel members, wherein the performance is determined by analysis of usage patterns of the panel formed from the selected panel members.

### BRIEF DESCRIPTION OF THE ACCOMPANYING DRAWINGS

Reference is now being made to the accompanying drawings in order to have a holistic understanding of the present disclosure, in which the elements are references with like numerals. These drawings should, however, not be construed as limiting the present disclosure, but are intended to be exemplary only.

FIG. 1 illustrates a schematic diagram of a wireless network in communication with the system in accordance with an embodiment of the invention;

FIG. 2 illustrates contribution of each member to each region or category;

FIG. 3 illustrates parameters before and after inserting PIA;

FIG. 4 is a system diagram depicting an exemplary mobile device.

### DETAILED DESCRIPTION

Disclosed below are representative embodiments of methods, apparatus and systems used for determining performance of a wireless network. The disclosed methods, apparatus and systems should not be construed as limiting in any way. Instead, the present disclosure is directed toward all novel and non-obvious features and aspects of the various disclosed methods, apparatus, systems, and equivalents thereof, alone and in various combinations and sub-combinations with one another. The present disclosure is not limited to any specific aspect or feature, or combination thereof, nor do the disclosed methods, apparatus, systems, and equivalents thereof, alone and in various combination thereof, nor do the disclosed methods, apparatus, and systems require that any one or more specific advantages be present or problems be solved.

Although the operations of some of the disclosed methods, apparatus, and systems are described in a particular, sequential order for convenient presentation, it should be understood that this manner of description encompasses rearrangement, unless a particular ordering is required by specific language set forth below.

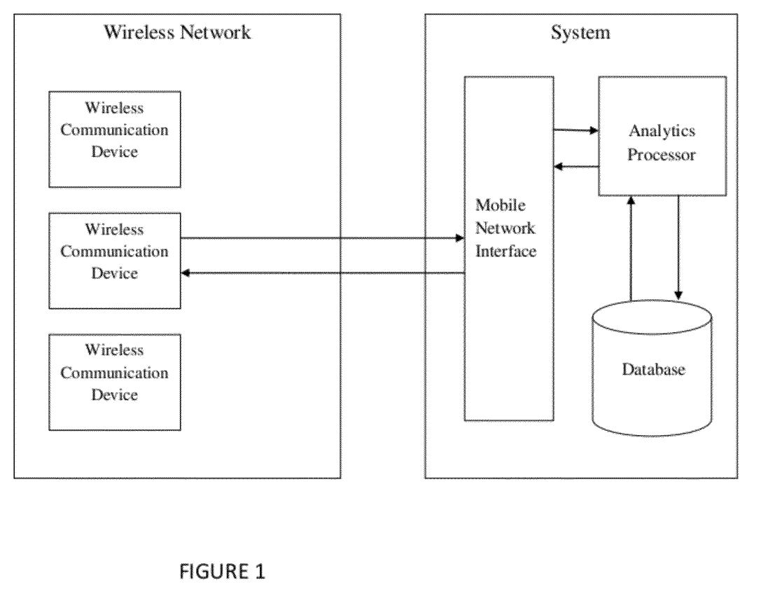

The wireless network includes a plurality of members having wireless communication devices in communication with the wireless network. The system for determining performance of a wireless network comprises of a mobile network interface, a database and an analytics processor as depicted in FIG. 1.

The mobile network interface is configured to obtain usage data of the wireless communication devices. The usage data may include any wireless network events.

The database is configured for storing the usage data of the plurality of members.

The analytics processor is configured for sorting the plurality of members in order of maximum number of past network events in a predetermined time period. The analytics is further configured to sort the network events in to different categories by applying at least one desired parameter. The analytics processor is further configured to choose a predetermined number of panel members with preference to those members having a higher number of network events in a higher number of categories for the desired parameter. The analytics processor is further configured to give preference to those members that reduce the variation in the total number of network events in the different categories for the selected panel members, wherein the performance of the wireless network is determined by analysis of usage patterns of the panel formed from the selected panel members.

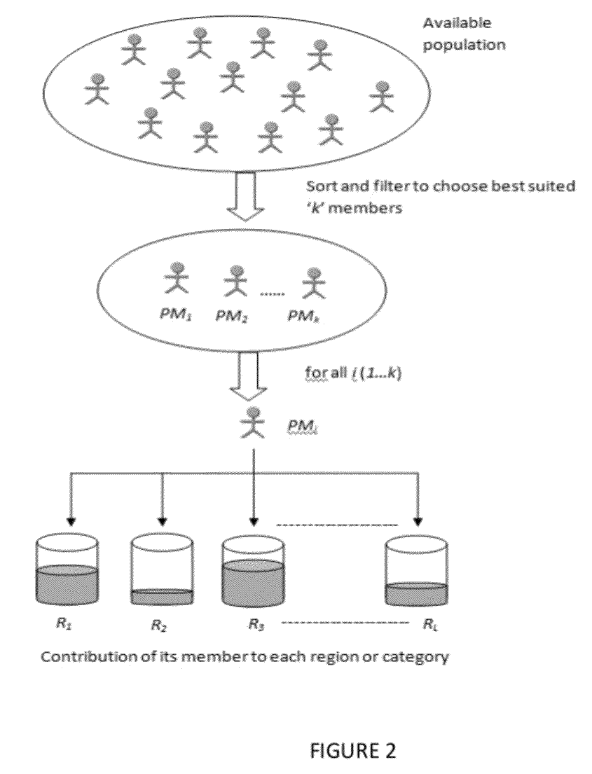

From the available pool of wireless device users a set of members are selected such that they provide the most diverse/informative information about the network. Without loss of generality, we assume that the primary entity is a user who uses a wireless device. This is accomplished by first sorting the list in order of maximum number of network events produced by the user of the wireless device. Based on predetermined parameters, first ‘k’ members (k>=3) are chosen. These members are the prospective panel members. The idea is to choose members who give the most data. Thus as a first rule, only the members giving maximum data are taken. The users are arranged in ordered manner in accordance to number of ‘events’ they generate. The area, over which the analysis is to be done, consists of several categories, such as but not limited to geographical locations and market segments. Every panel member has a contribution to each of the category. For example, the category chosen can be the geographical regions in the area under survey as depicted in FIG. 2.

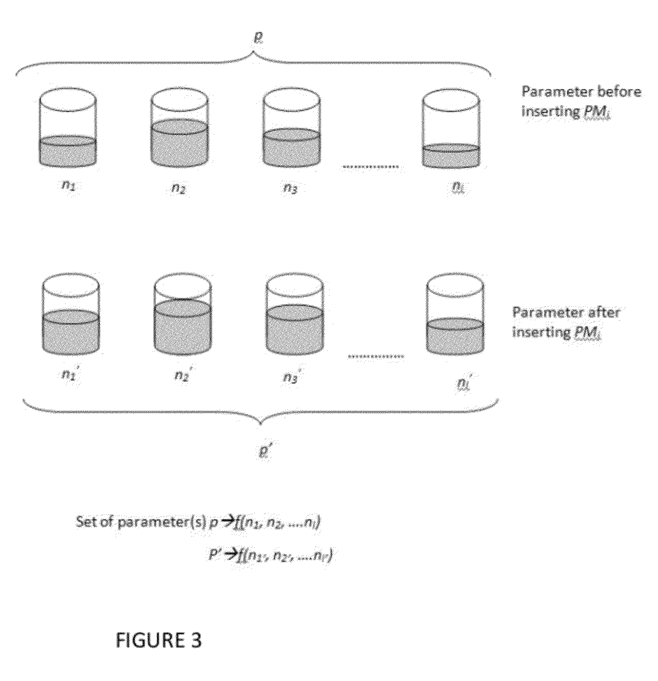

The wireless device which gives data from different categories is more useful than the person whose contribution is only in one category. Further to ensure observations are not biased to any category, the device/user should be chosen such that the total number of events registered in each category is equal within predetermined error rates. In FIG. 3, the number of events in each category/region before and after the individual contribution of each of the selected member is included is shown. The desired panel member is one whose wireless device makes contribution such that the above rules are satisfied. The desired panel member among these ‘k’ is the one whose wireless device contribution maximizes across the categories and reduces variation between the ‘event’ counts in the categories. This can be mathematically achieved in various ways using the parameter(s) derived from the number of events in each category. For example, the variance of the numbers of wireless ‘events’ in each category can be used. Along with this the number of events produced by users can be used. Computing the parameters for each selected member using data of number of events in categories before and after his addition, and comparing the performance of the selected members based on these parameters the ‘best’ suited member is selected into the panel and the rest of the members are returned to the pool. The selection of new panel members can be stopped when some ‘error’ rate or acceptable ‘sigma’ for the estimates of the comparative study is reached.

This procedure continues till a predetermined number of panel members are inducted. These decisions are taken based on the past usage data as declared by the member. For the estimation to be accurate, the present data that is being studied should be in such a way that the conditions are ‘true’ within predetermined error rates. For the system to be trained the observations are used as corrective normalization factors for the further choice of the panel member. Based on the observations made on the device, the category wise information is obtained and is compared against the category wise information as declared and a correction factor is achieved.

For example, we can choose the limiting factor for the selection of new panel members to be number of ‘events’ in each category. ‘Event’ refers to any change of state of the system. The limiting factor is not number of members but the number of ‘events’.

On taking that, there are ‘n’ number of panel members and ‘1’ regions, the coverage window for a particular time span would be as follows:

| | | | | | | Panel |
|---|---|---|---|---|---|---|
| | Regions | | | | | member |
| Panel | R_1 | R_2 | R_3 | . . . | R_l | Total |
| P_1 | x_11 | x_12 | x_13 | | x_1l | X_1. |
| P_2 | x_21 | x_22 | x_23 | | x_2l | X_2. |
| P_3 | x_31 | x_32 | x_33 | | x_3l | |
| . . . | | | | | | |
| . . . | | | | | | |
| P_n | x_n1 | x_n2 | x_n3 | | x_nl | X_n. |
| Region | X_.1 | X_.2 | X_.3 | | X_.l | |
| Total | | | | | | |

In the above table, the ‘xᵢⱼ’ indicates the number of observations (or events) that would happen in that cell or category. The ‘xᵢⱼ’s are unknown and are random. However, from the past usage pattern, one can predict possible distribution of the same. The numbers of failures in given time frame tend to follow a Poisson distribution.

The Poisson distribution is λ at individual level. This can be taken for a month. The estimate of the same can be used as row total stated in the table. If data is to be collected for 4 months, simply multiply the parameters by 4. This way, one would get clear ‘expected’ sample size which would lead to desired panel size as well as desired time frame for assessment.

| | | | | | | Panel |
|---|---|---|---|---|---|---|
| | Regions | | | | | member |
| Panel | R1 | R2 | R3 | . . . | R_l | Total |
| P1 | λ_11 | λ_12 | λ_13 | | λ_1l | λ_1. |
| P2 | λ_21 | λ_22 | λ_23 | | λ_2l | λ_2. |
| P3 | λ_31 | λ_32 | λ_33 | | λ_3l | |
| . . . | | | | | | |
| . . . | | | | | | |
| P_n | λ_n1 | λ_n2 | λ_n3 | | λ_nl | λ_n. |
| Region | λ_.1 | λ_.2 | λ_.3 | | λ_.l | |
| Total | | | | | | |

In this case, if there are a category of usage (for a particular geographic location, device type, service provider, service type), if n is number of observations, the error rate with minimal assumption is less than 1/(2*√n). In situation stated n is random follows Poisson distribution of relevant column λ. It would be safe to substitute n with λ/2. This is the desired sample.

It is agreed that the ‘n’ is random, however, as number of panel members is high, and we have underlying expected number of trails based on past data for specific category, one would safely use binomial distribution to assess the realized number of incidences are larger or close to desired n. If ‘N’ is number of incidence that have happened in timeframe ‘t’, for time period ‘t0’ one would assume, Poisson distribution with λ equal to N*t0/t; and one need to ensure Probability of (n>desired number)>99%.

### Specific Embodiments are Described Below

A method for determining performance of a wireless network, by selecting a set of panel members from a list of members of the wireless network comprising sorting the list of members in order of maximum number of past events in a predetermined time period and further sorting the events in to different categories by applying at least one desired parameter, choosing a predetermined number of panel members with preference to those members having a higher number of events in a higher number of categories for the desired parameter and additionally giving preference to those members that reduce the variation in the total number of events in the different categories for the selected panel members, wherein the performance is determined by analysis of usage patterns of the panel formed from the selected panel members.

Such method(s), wherein the event includes a call, a message, application usage, pattern thereof, device performance, service transactions or an exchange of data.

Such method(s), wherein the desired parameter includes market segment, revenue segment, population density, member devices or geographical location.

Such method(s), wherein the performance determined is related to consumer experience.

Such method(s), wherein for the market segment the categories include the ‘market segments’ are the categories of users to which services are offered, may be based on but not limited to regions, product or services offerings, etc.

Such method(s), wherein for the revenue segment the categories include Revenue segments are possible offerings type to the users, such as calls, data, video among others.

Such method(s), wherein for the population density the categories include the categories of geographical regions that have a similar level of persons/device users within a predetermined dimensions of land.

Such method(s), wherein for the parameter geographical locations, the categories include regions within the geographical location.

Such method(s), further comprising forming a plurality of panels for a plurality of parameters.

Such method(s), further comprising forming a consolidated panel by selecting a member from each of the plurality of panels.

Such method(s), wherein the selection of a member from the plurality of panels involves preference to those members having a higher number of events in a higher number of categories for the desired parameter; and additionally giving preference to those members that reduce the variation in the total number of events in the different categories for the consolidated panel.

Such method(s), wherein usage pattern includes geographical locations, network connectivity, call drops, call durations, individual applications usage, services transactions and network destinations.

### Further Specific Embodiments are Described Below

A system for determining performance of a wireless network, the wireless network including a plurality of members having wireless communication devices in communication with the wireless network, the system comprising a mobile network interface configured to obtain usage data of the wireless communication devices; the usage data including any wireless network events, a database for storing the usage data of the plurality of members, an analytics processor for sorting the plurality of members in order of maximum number of past network events in a predetermined time period and further sorting the network events in to different categories by applying at least one desired parameter, the analytics processor further configured to choose a predetermined number of panel members with preference to those members having a higher number of network events in a higher number of categories for the desired parameter; and additionally giving preference to those members that reduce the variation in the total number of network events in the different categories for the selected panel members, wherein the performance of the wireless network is determined by analysis of usage patterns of the panel formed from the selected panel members.

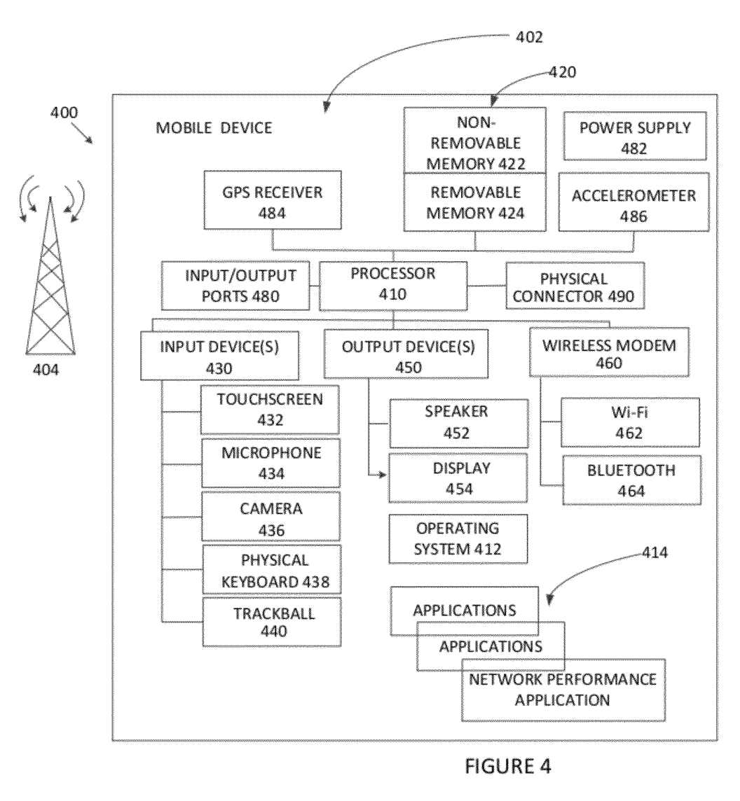

FIG. 4 is a system diagram depicting an exemplary mobile device 400 including a variety of optional hardware and software components, shown generally at 402, that can be adapted to perform the disclosed methods. Any components 402 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 404, such as a cellular or satellite network. Alternatively, other fixed or mobile devices such as desktop or laptops computers, or tablet computers can be used.

The illustrated mobile device 400 can include a controller or processor 410 (e.g., signal processor, microprocessor, ASIC, or other control and processing logic circuitry) for performing such tasks as signal coding, data processing, input/output processing, power control, and/or other functions. An operating system 412 can control the allocation and usage of the components 402 and support for one or more application programs 414. The application programs can include common mobile computing applications (e.g., email applications, calendars, contact managers, web browsers, messaging applications), or any other computing application.

The illustrated mobile device 400 can include memory 420. Memory 420 can include non-removable memory 422 and/or removable memory 424. The non-removable memory 422 can include RAM, ROM, flash memory, a hard disk, or other well-known memory storage technologies. The removable memory 424 can include flash memory or a Subscriber Identity Module (SIM) card, which is well known in GSM communication systems, or other well-known memory storage technologies, such as “smart cards.” The memory 420 can be used for storing data and/or code for running the operating system 412 and the applications 414. Example data can include web pages, text, images, sound files, video data, or other data sets to be sent to and/or received from one or more network servers or other devices via one or more wired or wireless networks. The memory 420 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 400 can support one or more input devices 430, such as a touch screen 432, microphone 434, camera 436, physical keyboard 438 and/or trackball 440 and one or more output devices 450, such as a speaker 452 and a display 454. Other possible output devices (not shown) can include piezoelectric or other haptic output devices. Some devices can serve more than one input/output function. For example, touchscreen 432 and display 454 can be combined in a single input/output device.

A wireless modem 460 can be coupled to an antenna (not shown) and can support two-way communications between the processor 410 and external devices, as is well understood in the art. The modem 460 is shown generically and can include a cellular modem for communicating with the mobile communication network 404 and/or other radio-based modems (e.g., Bluetooth or Wi-Fi). The wireless modem 460 is typically configured for communication with one or more cellular networks, such as a GSM network for data and voice communications within a single cellular network, between cellular networks, or between the mobile device and a public switched telephone network (PSTN).

The mobile device can further include at least one input/output port 480, a power supply 482, a satellite navigation system receiver 484, such as a Global Positioning System (GPS) receiver, an accelerometer 486, and/or a physical connector 490, which can be a USB port, IEEE 1394 (FireWire) port, and/or RS-232 port. The illustrated components 402 are not required or all-inclusive, as any components can deleted and other components can be added.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The invention being thus described, it will be obvious that the same may be varied in many ways. Such variations are not to be regarded as a departure from the spirit and scope of the invention, and all such modifications as would be obvious to one skilled in the art are intended to be included in the detailed description.

1. A method for determining performance of a wireless network, by selecting a set of panel members from a list of members of the wireless network comprising:
sorting the list of members in order of maximum number of past events in a predetermined time period and further sorting the events in to different categories by applying at least one desired parameter;
choosing a predetermined number of panel members with preference to those members having a higher number of events in a higher number of categories for the desired parameter; and additionally giving preference to those members that reduce the variation in the total number of events in the different categories for the selected panel members, wherein the performance is determined by analysis of usage patterns of the panel formed from the selected panel members.

2. The method as claimed in claim 1 wherein the event includes a call, a message, application usage, pattern thereof, device performance, service transactions or an exchange of data.

3. The method as claimed in claim 1 wherein the desired parameter includes market segment, revenue segment, population density, member devices or geographical location.

4. The method as claimed in claim 1 wherein the performance determined is related to consumer experience.

5. The method as claimed in claim 3 wherein ‘market segments’ are the categories of users to which services are offered, may be based on but not limited to regions, product or services offerings, etc.

6. The method as claimed in claim 3 wherein ‘revenue segments’ are possible offerings type to the users, such as calls, data, video among others.

7. The method as claimed in claim 3 wherein for the population density the categories include the categories of geographical regions that have a similar level of persons/device users within a predetermined dimensions of land.

8. The method as claimed in claim 3 wherein for the parameter geographical locations, the categories include regions within the geographical location.

9. The method as claimed in claim 1 further comprising forming a plurality of panels for a plurality of parameters.

10. The method as claimed in claim 9 further comprising forming a consolidated panel by selecting a member from each of the plurality of panels.

11. The method as claimed in claim 10 wherein the selection of a member from the plurality of panels involves preference to those members having a higher number of events in a higher number of categories for the desired parameter; and additionally giving preference to those members that reduce the variation in the total number of events in the different categories for the consolidated panel.

12. The method as claimed in claim 1 wherein usage pattern includes geographical locations, network connectivity, call drops, call durations, individual applications usage, services transactions and network destinations.

13. A system for determining performance of a wireless network, the wireless network including a plurality of members having wireless communication devices in communication with the wireless network, the system comprising:
a mobile network interface configured to obtain usage data of the wireless communication devices; the usage data including any wireless network events;
a database for storing the usage data of the plurality of members;
an analytics processor for sorting the plurality of members in order of maximum number of past network events in a predetermined time period and further sorting the network events in to different categories by applying at least one desired parameter, the analytics processor further configured to choose a predetermined number of panel members with preference to those members having a higher number of network events in a higher number of categories for the desired parameter; and additionally giving preference to those members that reduce the variation in the total number of network events in the different categories for the selected panel members, wherein the performance of the wireless network is determined by analysis of usage patterns of the panel formed from the selected panel members.

14. A computer-readable storage medium comprising computer-executable instructions for performing a method for determining performance of a wireless network by selecting a set of panel members from a list of members of the wireless network, the method comprising:
sorting the list of members in order of maximum number of past events in a predetermined time period and further sorting the events in to different categories by applying at least one desired parameter; and
choosing a predetermined number of panel members with preference to those members having a higher number of events in a higher number of categories for the desired parameter; and additionally giving preference to those members that reduce the variation in the total number of events in the different categories for the selected panel members, wherein the performance is determined by analysis of usage patterns of the panel formed from the selected panel members.

15. The computer-readable storage medium of claim 14, wherein the event includes a call, a message, application usage, pattern thereof, device performance, service transactions or an exchange of data.

16. The computer-readable storage medium of claim 14, wherein the desired parameter includes market segment, revenue segment, population density, member devices or geographical location.

17. The computer-readable storage medium of 14, wherein the performance determined is related to consumer experience.

18. The computer-readable storage medium of 16, market segments correspond to categories of users to which services are offered.

19. The computer-readable storage medium of 16, wherein revenue segments are associated with possible offering types to users, wherein offering types include calls, data, and video.

20. The computer-readable storage medium of claim 16, the population density is associated with geographical regions having similar levels of persons/device users within a predetermined dimensions of land.
